(19) United States
(12) Patent Application Publication
(10) Pub. No.: US 2013/0008270 A1
(43) Pub. Date: Jan. 10, 2013

(54) LIMIT SWITCH ASSEMBLY

(75) Inventors: Ronald Lee Giovannone, Austintown, OH (US); Matthew Ryan Wilhelm, Brunswick, OH (US)

(73) Assignee: NOOK INDUSTRIES, Cleveland, OH (US)

(21) Appl. No.: 13/543,062

(22) Filed: Jul. 6, 2012

Related U.S. Application Data
(60) Provisional application No. 61/505,571, filed on Jul. 8, 2011.

(51) Int. Cl. F16H 19/02

(52) U.S. Cl. 74/89.37

(57) ABSTRACT

A limit switch assembly for a screw jack includes a worm screw jack assembly, a gear mechanism and a limit switch mechanism. The worm screw jack assembly includes a worm shaft, a worm gear and a screw jack shaft. The gear mechanism includes a piston, an adapter block, a planetary gearbox, and a gearbox shaft. The piston is drivable by the worm gear and engages the gearbox and the gearbox shaft extends out of the adapter block on an opposing side of the piston. The limit switch mechanism is coupled to the screw jack by the gear mechanism, and includes at least two limit switches operable to control movement of the screw jack shaft. The planetary gearbox may have interchangeable ratios to accommodate worm gear screw jacks with an increased number of gear ratios, drive screw lead, and length of travel requirement combinations.

### CROSS-REFERENCE TO RELATED APPLICATION

This application claims the benefit of U.S. Provisional Patent Application Ser. No. 61/505,571, entitled LIMIT SWITCH ASSEMBLY FOR WORM GEAR SCREW JACK and filed Jul. 8, 2011, the entire disclosure of which is incorporated herein by reference, to the extent that it is not conflicting with the present application.

### BACKGROUND

Screw jacks are used in a variety of applications. Screw jacks can transmit linear force or movement based upon movement generated by a rotational motor. A worm gear screw jack is one example of a screw jack type. The movement of a worm screw jack can be controlled by various structure and methods, such as for example, by limit switches.

Limit switches for worm gear screw jacks generally include switches that are directly operated with the extension or retraction of an actuating rod or drive screw, or driven by the input revolutions of the worm shaft that in turn drive the extension or retraction of an actuating rod or drive screw. Limit switch systems directly operated with the extension or retraction of an actuating rod or drive screw generally require an outer cylinder to move relative to and on which the switches mount. Types of worm gear screw jacks in which an axially static screw rotates to drive a translating nut may not have an outer cylinder or actuator rod for use. Certain limit switches operated by the revolution count of an input shaft operate independent of the translating components of the screw jack. Limit switches of this type are commercially available for general industry.

However, cost considerations, physical size limitations and functionality limitations make their specific use on worm gear screw jacks of essential all sizes and applications impractical.

### SUMMARY

According to an exemplary embodiment of the present invention, a limit switch assembly for a screw jack includes a limit switch mechanism and a planetary gearbox.

The planetary gearbox has interchangeable ratios to accommodate worm gear screw jacks with an increased number of gear ratios, drive screw lead, and length of travel requirement combinations. A lightweight enclosure houses the limit switch mechanism. The planetary gearbox is housed in an adapter block that couples the limit switch mechanism to the screw jack. The adapter block and enclosure are streamlined to minimize the envelope dimensions of the installed limit switch assembly. The limit switch mechanism can also be configured with an additional Hall effect sensor, Reed switch, potentiometer, or encoder. A method of mounting the limit switch mechanism and planetary gearbox to the screw jack housing and worm shaft is also disclosed.

### BRIEF DESCRIPTION OF THE DRAWINGS

Features and advantages of the invention will become apparent from the following detailed description made with reference to the accompanying drawings.

FIG. 1 is a perspective view of a limit switch and worm gear screw jack assembly;

FIG. 2 is a top view of the limit switch and worm gear screw jack assembly of FIG. 1;

FIG. 3 is a right side view of the limit switch and worm gear screw jack assembly of FIG. 1;

FIG. 4 is a sectional view of the limit switch and worm gear screw jack assembly of FIG. 1, shown along the line 4-4 of FIG. 3;

FIG. 5 is a sectional view of the limit switch and worm gear screw jack assembly of FIG. 1, shown along the line 5-5 of FIG. 3;

FIG. 6 is a sectional view of the limit switch and worm gear screw jack assembly of FIG. 1, shown along the line 6-6 of FIG. 2;

FIG. 7 is a perspective view, partially in section, of the limit switch and worm gear screw jack assembly of FIG. 6;

FIG. 8 is a sectional view of the limit switch and worm gear screw jack assembly of FIG. 1, shown along the line 8-8 of FIG. 3;

FIG. 9 is a perspective view, partially in section, of the limit switch and worm gear screw jack assembly of FIG. 8;

FIG. 10 is a perspective view of the limit switch and worm gear screw jack assembly of FIG. 1, shown with the limit switch cover removed; and

FIG. 11 is a perspective view of only the limit switch mechanism of FIG. 1.

### DETAILED DESCRIPTION

The Detailed Description merely describes the preferred embodiments of the invention and is not intended to limit the scope of the invention in any way. Indeed, the invention as described by the specification is broader than and unlimited by the preferred embodiments, and the terms used in the claims have their full ordinary meaning.

Also, while the exemplary embodiments described in the specification and illustrated in the drawings relate to limit switch assembly for a worm gear screw jack, it should be understood that many of the inventive features described herein may be applied to other devices, including, for example, other devices for motion control of a rotating object.

The present invention is directed to motion control of a rotating object. In one embodiment of the invention, a limit switch assembly for worm gear screw jacks is provided in which the switches operate at predetermined extended and retracted screw jack positions. Signals provided by the operated switches are used in a motion control system to monitor a translating load at these predetermined positions. Also, the limit switch may be used to control a motorized worm gear screw jack so that power to a motor is turned off and braking means is engaged before the designed limits of mechanical travel are reached.

An exemplary limit switch and worm gear screw jack assembly will now be discussed. The limit switch assembly is driven by the input revolutions of a worm shaft and utilizes a low cost limit switch mechanism and a planetary gearbox. This arrangement provides an economic limit switch solution with added functionality and minimized impact on the screw jack dimensional envelope. The planetary gearbox is available with interchangeable ratios to accommodate worm gear screw jacks with an increased number of worm gear ratios, drive screw lead, and length of travel requirement combinations. A low cost plastic enclosure houses the limit switch mechanism in place of a bulky and costly fabricated metal piece. The planetary gearbox is housed in an adapter block that couples the limit switch mechanism to the screw jack. The adapter block and enclosure are streamlined to minimize the envelope dimensions of the installed limit switch assembly. The limit switch mechanism can also be configured with an additional Hall effect sensor, Reed switch, potentiometer, or encoder.

An exemplary method of the invention will now be discussed. An inventive method includes incorporating a uniquely configured limit switch mechanism and planetary gearbox in a limit switch assembly for a worm gear screw jack, and providing limit switch positions for extended and retracted screw jack positions adjustable throughout the full length of travel. The method may include configuring the planetary gearbox ratio to accommodate full screw jack travel lengths while minimizing the number of worm shaft input rotations required to cycle the limit switch mechanism. The method may include mounting the limit switch mechanism and planetary gearbox to the screw jack housing and worm shaft. The planetary gearbox and limit switch mechanism may be coupled using an adapter shaft. The planetary gearbox input pinion may be fixed to the screw jack worm shaft and coupled to the planetary gearbox.

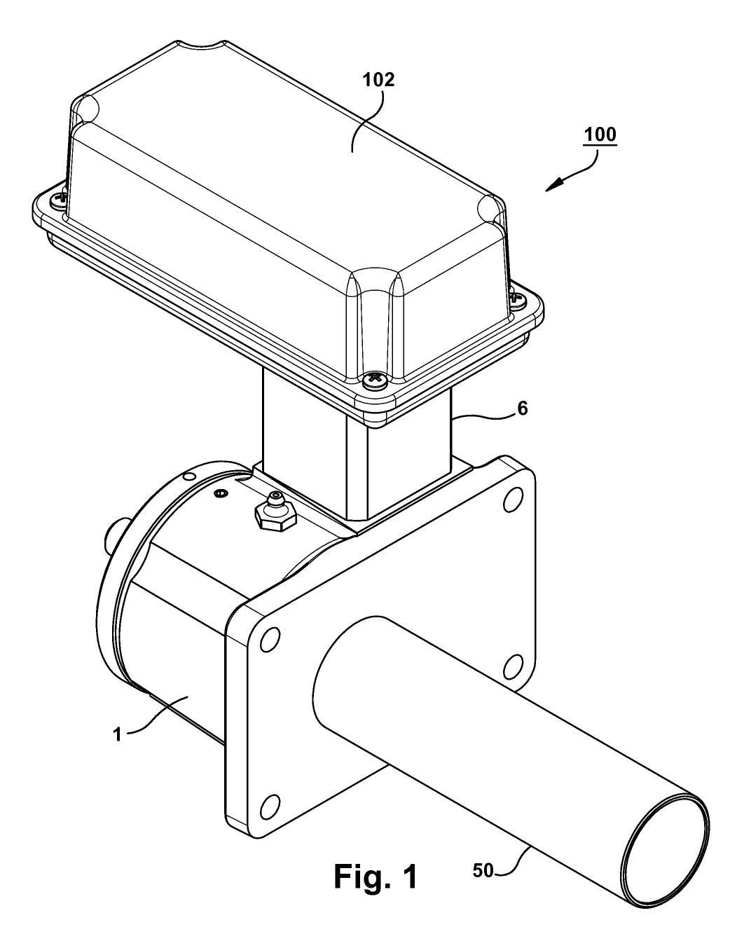

Referring now to the drawings, FIGS. 1-3 illustrate perspective, top, and right side views, respectively, of an assembly 100. The assembly 100 includes a worm gear screw jack 1, a planetary gearbox 4 with an adapter 6, and a limit switch mechanism within an enclosure 102. The worm gear screw jack 1 converts rotational input from a worm shaft 2 into axial translational output of a drive screw, travel nut, or actuator rod to move a load a linear distance. The linear distance a load travels directly relates to the number of worm shaft input rotations.

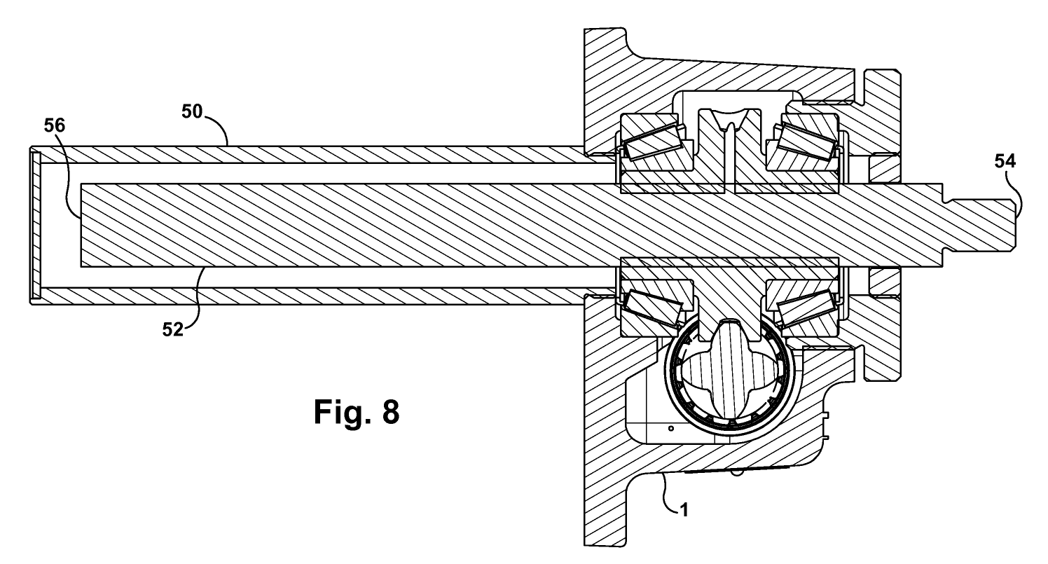

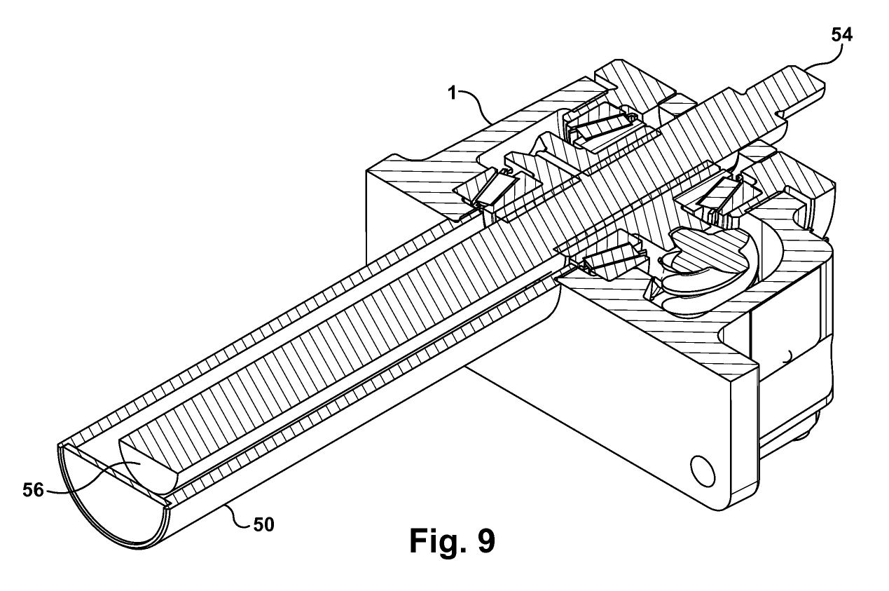

The worm gear screw jack includes a shroud 50 protecting a screw jack shaft 52. As best seen in FIGS. 8 and 9, a first end of the screw jack shaft 52 is an exposed rotational input end 54. An opposing second end 56 is protected within the shroud 50.

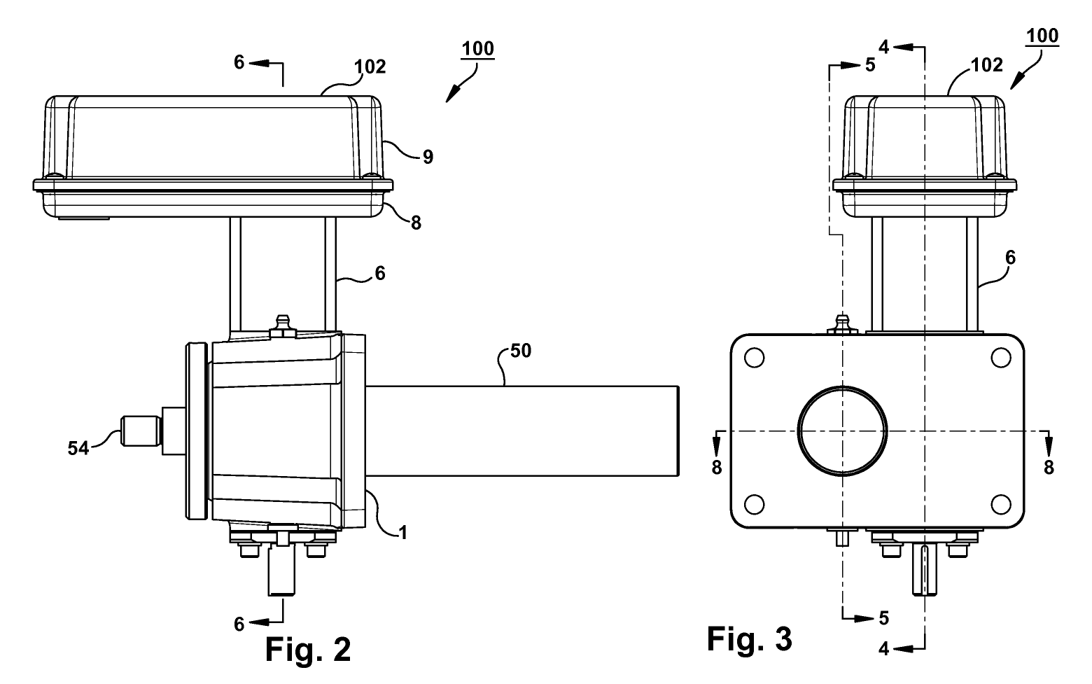

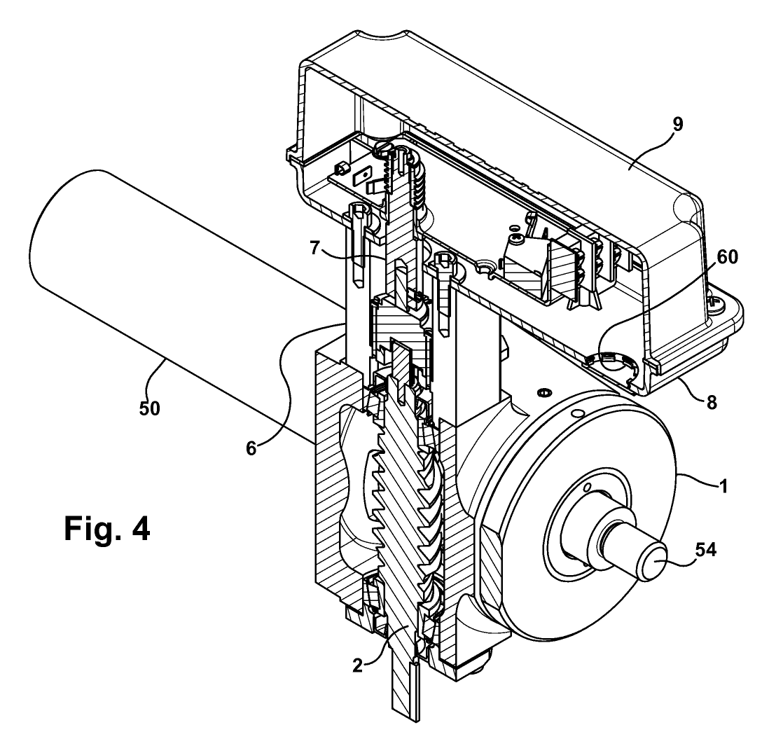

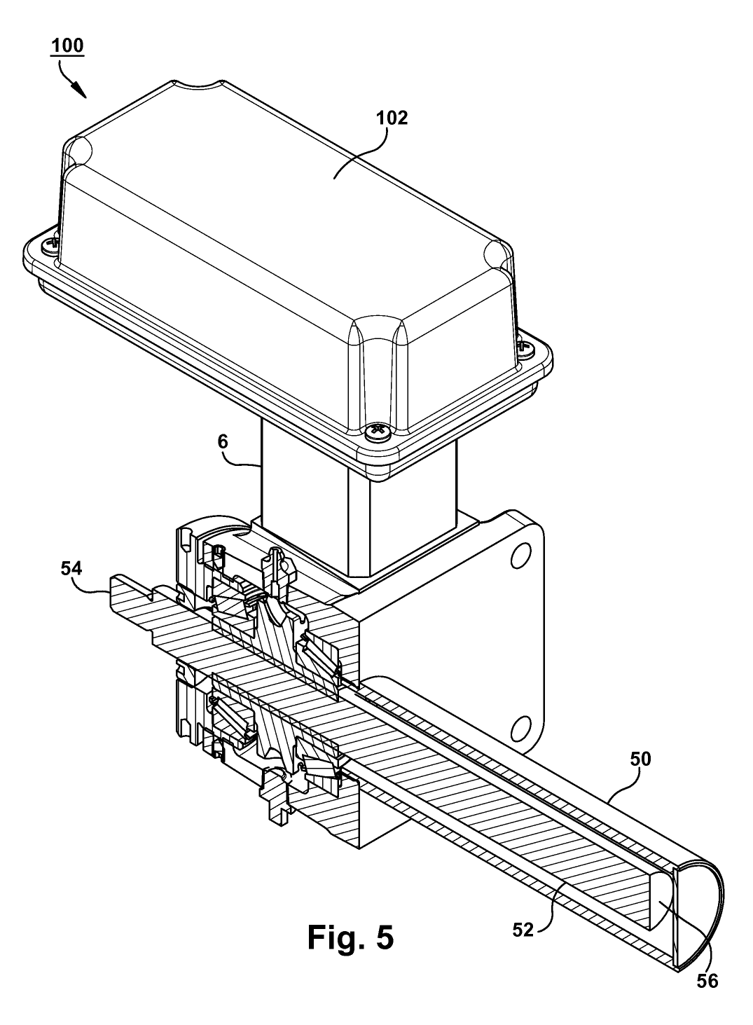

Various sectional views of the limit switch and worm gear screw jack assembly 100 of FIG. 1 are shown in FIGS. 4-6 and 8. The sectional views are along respective lines in FIG. 2 or 3. Additional perspective views, partially in section, of the limit switch and worm gear screw jack assembly are shown in FIGS. 7 and 9.

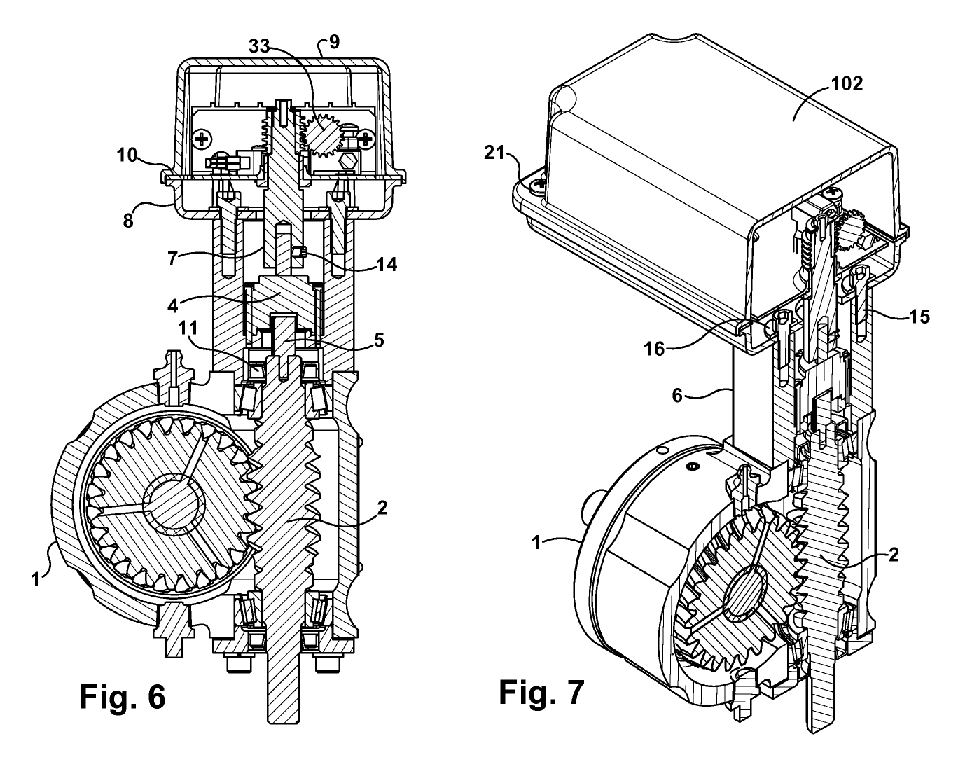

The worm gear jack assembly 1 is coupled to a limit switch assembly by a planetary gear box 4. The planetary gearbox 4, as best shown in FIG. 6, is of optional ratio with an input pinion 5 that fixes into the worm shaft 2. As shown, an adapter block 6 mounts to the worm screw jack 1 and houses the gearbox 4 and radial shaft oil seal 11. The assembly 100 also includes a limit switch mechanism 3, a protective enclosure 102 that houses the limit switch mechanism 3 and mounts to the adapter block 6 and an adapter shaft 7 that translates the output rotation of the planetary gearbox 4 into the limit switch mechanism 3.

As mentioned, a limit switch mechanism 3 within the enclosure 102 is used to control movement of the worm gear screw jack. Specifically, the limit switch mechanism provides electrical contact closures to signal the end of travel limits of a worm gear screw jack. The limit switch assembly couples directly to the worm shaft 2 on an opposing end of the rotational input side. Clockwise and counterclockwise input worm shaft rotation moves the limit switch mechanism to predetermined adjustable operating positions. The limit switch operating positions correspond directly to specified extended and retracted worm gear screw jack 1 load positions.

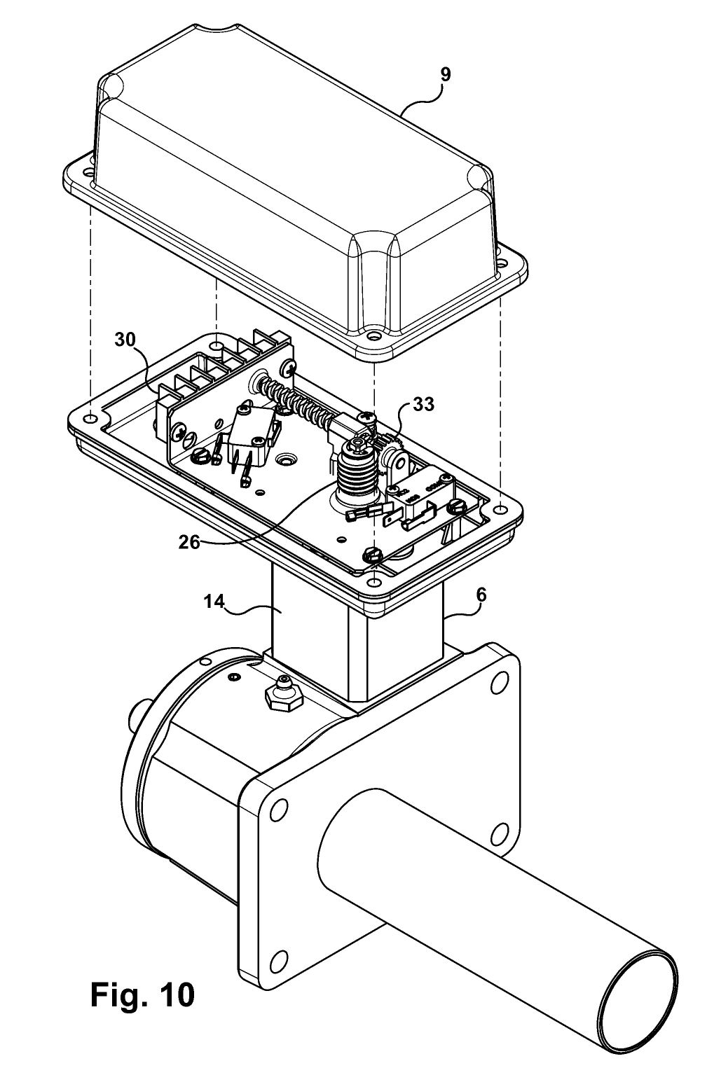

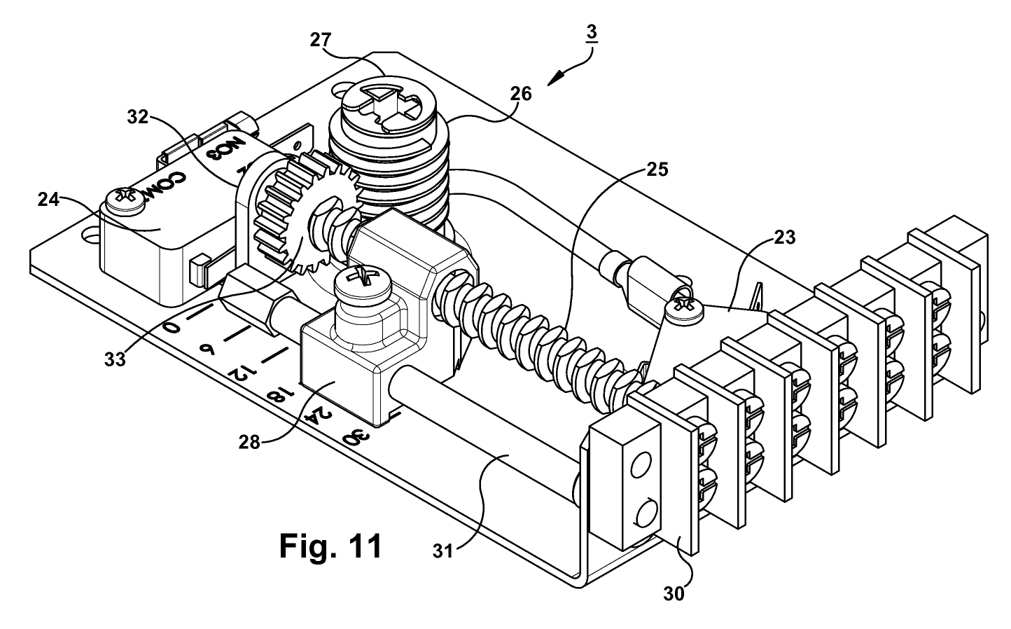

The limit switch mechanism 3 is best shown in FIGS. 10 and 11. FIG. 10 is a perspective view of the limit switch and worm gear screw jack assembly 100 with the limit switch cover 9 removed. FIG. 11 shows only the limit switch mechanism 3.

The limit switch mechanism 3 is configured to incorporate in the assembly 100. The mechanism 3 converts rotational movement of a brass worm 26 to translate a travel block 28 across a lead screw 25. In one embodiment, the block is plastic and moves at a 10:1 ratio. A plunger type limit switch 23, 24 is mounted at the travel extents of the travel block 28. Rotation of the brass worm 26 translates the travel block 28 to compress and operate the plunger type switch 23, 24. The operated switch provides a contact closure used in a motion control system to stop the input motor in the direction of the operated switch. A number of brass worm 26 input rotations, e.g. 120, are required to translate the travel block 28 from one plunger type limit switch 23, 24 to the other. The switches 23, 24 are wired to a terminal block 30 for ease of connection to the motion control system.

The limit switch mechanism 3 can also be configured with the addition of a potentiometer, Reed switch, Hall effect sensor or encoder. These and other similar sensors mount directly to mechanism 3 and are directly driven by the rotation of the limit switch adapter shaft 7 on which the brass worm 26 is mounted. These additional features operate independently of the extended and refracted position plunger type limit switches 23, 24. The additional sensors may be wired to the terminal block 30 along with the standard plunger type limit switches 23, 24.

The planetary gearbox 4 is selected in a configuration to incorporate in the limit switch assembly. An input pinion 5 is provided with the gearbox 4 and may include all necessary mounting hardware. The gearbox 4 is selected to a specific ratio as required per application and is available in 1, 2 or 3-stage versions. In one embodiment, the maximum 1 stage ratio gearbox 4 is 6.75:1, the maximum 2-stage ratio is 46:1 and the maximum 3-stage ratio is 308:1. In this example, the length of the planetary gearbox 4 increases by 11 mm with each additional stage.

The maximum number of worm shaft 2 input rotations required to translate a load across a specified linear travel distance determines the planetary gearbox 4 ratio. The gearbox 4 ratio multiplied by the 120 maximum input rotations of the limit switch mechanism 3 results in the maximum allowable input rotations of the limit switch assembly. Variables exist in determining the rotation count capacity requirement of the limit switch assembly, such as for example, the screw jack 1 worm gear ratio, the drive screw lead and the required linear travel.

The input pinion 5 included with the planetary gearbox 4 directly drives the gearbox 4 by the worm shaft 2 rotation of the jack 1. One end of the pinion 5 is the input spur gear profile and the opposing end is machined to a diameter with a resulting shoulder to the gear profile. Two pinion 5 versions with different spur gear profiles will accommodate all planetary gearbox 4 ratio options. A standard worm shaft 2 of a given screw jack 1 size is modified by reaming a corresponding hole on the worm shaft 2 extension end face. The pinion 5 is pressed into the reamed hole of the worm shaft 2 and secured with retaining compound. The worm shaft 2 is then conventionally assembled in the screw jack 1.

The planetary gearbox 4 pilots and mounts in an adapter block 6 using its supplied hardware. A separate adapter block 6 is needed for each screw jack 1 tonnage size but each block 6 utilizes the same planetary gearboxes 4. The length of the adapter block 6 accommodates planetary gearboxes 4 of 1, 2 and 3 stages. Mounting the adapter block 6 to the worm gear screw jack 1 aligns the pinion 5 fixed in the worm shaft 2 into the planetary gearbox 4. The adapter block 6 pilots into the jack housing and faces to the screw jack worm shaft bearings. Through a countersunk clearance hole pattern, the adapter block 6 is secured to the screw jack housing tapped threads with socket head cap screws and spring lock washers. Other types of conventional hardware may be used in the practice of the invention. The size of the mounting hardware is dictated by the tonnage size of the screw jack 1. The end of the adapter block 6 opposite of the screw jack 1 has 4 tapped holes for limit switch enclosure 102 mounting.

The limit switch mechanism 3 is enclosed in a protective and accessible enclosure 102. The enclosure includes a cover 9 and a base 8, and may be formed from plastic, such as for example, mold injected ABS/PC plastic. The low cost plastic enclosure houses the limit switch mechanism in place of a bulky and costly fabricated metal piece. The base enclosure piece 8 mounts to the adapter block 6 with ¼″-20 socket head cap screws 15 and ¼″ flat washers 16. The limit switch mechanism 3 mounts to molded standoffs in the base enclosure piece 8 using #6 thread cutting screws, or other suitable hardware.

Self-tapping brass inserts with #10-32 internal threads are installed in molded holes in the enclosure base piece 8. The enclosure cover 9 is secured to the base 8 using #10-32 pan head screws 21 and #10 flat washers 22 through clearance holes in the top piece 3 into the brass inserts 17 in the base piece 8. A lip is molded onto the flange profile of the top piece 3 to pilot over the base enclosure piece 8 flange profile. A neoprene rubber gasket 10 fits inside the top enclosure piece 9 lip profile and is captured between the two enclosure pieces 8&9 forming a seal to the ambient environment.

The enclosure top piece 9 can be removed after installation to the screw jack 1 for limit switch assembly set up or adjustment then securely replaced. An access hole for standard ½″ NPT electrical fitting is located in the base 8 near the limit switch mechanism 3 terminal strip.

An adapter shaft 7 couples the planetary gearbox 4 of a given ratio to the brass worm 26 of the limit switch mechanism 3. One end of the adapter shaft 7 is reamed to fit over the output shaft of the planetary gearbox 4. A 0.125″ thick gage block is used to space the adapter shaft 7 from the pilot face of the gearbox 4. The adapter shaft 7 fixes to the gearbox 4 output shaft by tightening two #8-32 set screws 14 in radial tapped holes of the adapter shaft 7 and securing with thread locker. The opposite adapter shaft 7 end pilots through a brass bushing pressed in the limit switch mechanism 3 base plate. The brass worm 26 then slips over the shaft extension and secured with retaining rings 27. The adapter shaft 7 end has an OD flat mating with an ID flat in the brass worm 26 prohibiting relative rotation.

An exemplary limit switch assembly and set-up procedure will now be discussed. Any dimensions, hardware, shapes, and stock classifications are for example only, and are not intended to limit the scope of the invention.

The process of installing a limit switch assembly to a worm gear screw jack 1 begins with modifying the worm shaft 2 end face with a reamed hole for input pinion 5 insertion. After the input pinion 5 is pressed in place and secured with retaining compound, the worm shaft 2 may be installed in the screw jack 1. A radial shaft oil seal 11 is then pressed into the adapter block 6 to seal over the worm shaft 2 extension. The adapter block 6 is installed on the screw jack 1 housing with four socket head cap screws and split lock washers, or any suitable hardware or method, and secured with thread locker.

The adapter shaft 7 is inserted over the planetary gearbox 4 output shaft and spaced 0.125″ from the gearbox 4 output pilot face using a ⅛″ gage block (not shown). At this position, two #8-32 setscrews 14 are tightened in the adapter shaft 7 onto the gearbox 4 output shaft and secured with thread locker. The planetary gearbox 4 with adapter shaft 7 installed is mounted into the adapter block 6 using the hardware which may be provided with the gearbox 4. The input pinion 5 must be engaged with the planetary gearbox 4 in a proper arrangement.

Self-tapping brass inserts with #10-32 internal threads are installed in molded holes in the enclosure base piece 8 corners. The base piece 8 is mounted at the required orientation to the adapter block 6 with four ¼″-20 socket head cap screws and ¼″ split lock washers and secured with thread locker. A gasket-sealing compound is applied to the mating faces of the adapter block 6 and enclosure base piece 8. The limit switch mechanism 3 is then piloted over the protruding adapter shaft 7 end through the bushing in its base plate. Limit switch mechanism 3 is secured to the enclosure base piece 8 using four #6-32 thread cutting screws.

In this arrangement, the operating positions of the limit switch assembly corresponding to the specified worm gear screw jack 1 extended and retracted positions are now ready to be set. Whether clockwise or counterclockwise input rotation of the worm shaft 2 extends or retracts the screw jack 1 depends on which end of the worm shaft 2 is driven. The plunger type limit switch of the limit switch mechanism closest to the terminal block is referred to as limit switch one 23. The plunger type limit switch furthest from the terminal block and near the protruding adapter shaft is referred to as limit switch two 24. The screw jack 1 extended or refracted position first set on limit switch one 23 is referred to as Limit Switch Position No. 1. The remaining position set on limit switch two 24 is referred to as Limit Switch Position No. 2.

Facing the top of the limit switch mechanism 3 mounted on the enclosure base piece 8, one must first rotate the screw jack worm shaft 2 counterclockwise to Limit Switch Position No. 1. Any lash is removed from the limit switch mechanism 3 lead screw 25 by bending the lead screw end support 32 of the base plate. The lead screw 25 is turned until limit switch one 23 is contacted by the travel block 28. The lead screw 25 is then turned in reverse ⅛-¼ turn to just lose contact with limit switch one 23.

In this position, the brass worm 26 of the limit switch mechanism 3 should be slipped over the adapter shaft 7 end to mate with the worm gear 33 of the lead screw 25. The opposing inner flats of the brass worm 26 must align to the outer flats on the adapter shaft 7 end to restrain relative rotation. When the brass worm 26 slides on the adapter shaft 7 ensure the travel block 28 on the lead screw 25 has come back in contact with limit switch one 23. The brass worm 26 is secured to the adapter shaft 7 with two retaining rings 27.

The travel block setscrew 29 which retains the threaded adjusting rod 31 is now loosened. The hex head of the threaded adjusting rod 31 is adjusted as close to the travel block 28 as possible. The worm gear screw jack 1 is jogged to Limit Switch Position No. 2. The threaded adjusting rod 31 is turned until its hex head end contacts limit switch two 24. The travel block setscrew 29 is tightened to secure the position of the adjusting rod 31. In this arrangement, Limit Switch Position No. 1 and Limit Switch Position No. 2 corresponding to the screw jack 1 specified extended and retracted positions are now set.

As best seen in FIG. 4, a snap-in steel hole plug 60 is installed in the 0.875″ diameter access hole in the bottom of the enclosure base piece 8. Wires are secured to the terminal block 30 removing as much wire slack as possible. The required number of wires routed to the limit switch mechanism 3 terminal block 30 is dependent on the specified sensor option of the mechanism 3.

The enclosure cover piece 9 is secured to the base piece 8 using four #10-32 pan head screws and #10 split lock washers, or other suitable hardware. A neoprene rubber gasket 10 is captured between the enclosure base 8 and cover 9 pieces. The gasket 10 matches the mating flange profile of the enclosure base 8 and cover 9 pieces with clearance holes for the fasteners 21. The compressed gasket 10 and properly selected and installed fitting provide a sealed enclosure protecting the limit switch mechanism 3 from the ambient environment.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. An assembly comprising:
a worm screw jack assembly having a worm shaft, a worm gear and a screw jack shaft;
a gear mechanism having a piston, an adapter block, a planetary gearbox enclosed within the adapter block, and a gearbox shaft, wherein the piston is drivable by the worm shaft and engages the gearbox and the gearbox shaft extends out of the adapter block on an opposing side of the piston;
a limit switch mechanism coupled to the screw jack by the gear mechanism, the limit switch mechanism having at least two limit switches operable to control movement of the screw jack shaft.

2. The assembly of claim 1 wherein the piston is fixed in a co-axial arrangement to the worm shaft.

3. The assembly of claim 1 further comprises an adapter shaft, wherein the adapter shaft is co-axially engaged to the gearbox shaft.

4. The assembly of claim 3 wherein the worm shaft, the piston, the gearbox shaft and the adapter shaft are positioned along a common longitudinal axis.

5. A limit switch assembly comprising:
a gear mechanism having a piston, an adapter block, a planetary gearbox enclosed within the adapter block, and a gearbox shaft, wherein the piston is rotationally drivable and engages the gearbox and the gearbox shaft extends out of the adapter block on an opposing side of the piston;
an adapter shaft engaged to the gearbox shaft; and
a limit switch mechanism coupled to the gear mechanism by the adapter shaft, the limit switch mechanism having at least two limit switches operable to control movement of the screw jack shaft;
wherein the piston, the gearbox shaft and the adapter shaft are positioned along a common longitudinal axis.

6. The limit switch assembly of claim 5 further comprising a limit switch mechanism enclosure, the enclosure formed by one or more sections of ABS polycarbonate.

7. A limit switch mechanism for controlling motion of a rotating object, the limit switch mechanism comprising:
a coupler assembly for connecting the limit switch mechanism to the rotating object;
a worm shaft engaged to the coupler assembly;
a worm gear rotatably mated to the worm shaft;
a lead screw drivable by the worm gear in the rotational direction of the worm gear;
a first switch and a second switch, each switch mounted at opposing ends of the lead screw; and
a travel block positioned on the lead screw and linearly movable in either axial direction along the lead screw;
wherein travel positions in which the travel block is contiguous with the first switch or contiguous with the second switch each define a linear motion limit of an object engaged to the rotating object.

8. The limit switch mechanism of claim 7 further comprising a Hall effect sensor.

9. The limit switch mechanism of claim 7 further comprising a Reed switch.

10. The limit switch mechanism of claim 7 further comprising a potentiometer.

11. The limit switch mechanism of claim 7 further comprising an encoder.

12. The limit switch mechanism of claim 7 wherein at least one of the first switch and the second switch is a plunger style limit switch.

13. The limit switch mechanism of claim 7 further comprising a limit switch mechanism enclosure, the enclosure formed by one or more sections of ABS polycarbonate.

14. The limit switch mechanism of claim 7 wherein the coupler assembly comprises an adapter shaft, wherein the adapter shaft is co-axially engaged to the worm shaft.
